(19) United States
(12) Patent Application Publication
(10) Pub. No.: US 2024/0199023 A1
(43) Pub. Date: Jun. 20, 2024

(54) SYSTEM TO ASSIST VEHICLE TURNS DURING LIMITED VISIBILITY OF INCOMING VEHICLES BASED ON AN INTERSECTION TURNING CONFIDENCE INDEX

(71) Applicant: HERE GLOBAL B.V., EINDHOVEN (NL)

(72) Inventors: Jerome BEAUREPAIRE, COURBEVOIE (FR); Leon STENNETH, Chicago, IL (US); Jeremy Michael YOUNG, Chicago, IL (US)

(73) Assignee: HERE GLOBAL B.V., EINDHOVEN (NL)

(21) Appl. No.: 18/081,090

(22) Filed: Dec. 14, 2022

(51) Int. Cl. B60W 30/18; B60W 50/08; B60W 60/00

(52) U.S. Cl. CPC B60W 30/18159; B60W 50/08; B60W 60/0053; B60W 2552/05; B60W 2554/20; B60W 2554/40; B60W 2554/4026; B60W 2554/4029; B60W 2555/20; B60W 2556/10

(57) ABSTRACT

A system, a method and a computer program product are provided, for example, to assist vehicle turns during limited visibility of incoming vehicles based on a turning confidence index for a left turn decision. For example, the system may obtain a plurality of traffic features related to the intersection of the road based on historical road features and/or real-time road features associated with the road. Using a trained machine learning model, a turning confidence index for the intersection of a road and/or a driving decision associated with attempting to turn at the intersection of the road may be determined.

### TECHNOLOGICAL FIELD

An example aspect of the present disclosure generally relates to determine a driving decision at an intersection based on traffic features associated with the intersection, and more particularly, but without limitation relates to a system, a method, and a computer program product for using a turning confidence index to determine a driving decision at an intersection based on traffic features associated with the intersection.

### BACKGROUND

Driving a motor vehicle or riding in an autonomous vehicle presents challenges in navigating streets and particularly when making turns, especially left turns. In some intersections, when turning left, drivers have not only to pay attention to the incoming traffic but also to the presence of light vehicles (bikes, e-bikes, kick-scooters, etc), which may be coming from both directions of traffic. In some cases, those light vehicles are hidden behind parked vehicles and become visible only very late, requiring an instant reaction by the turning vehicle. If a car has engaged in a left turn and suddenly sees or detects such a vehicle, then it has to stop in most cases, stopping in the middle of the road with incoming vehicles, which is extremely dangerous. This will only get worse in the future with the rise of shared electric vehicles which become very popular and are able to drive at speed around 35 mph, sometimes higher, thus surfacing even faster in such intersection and forcing drivers to take very quick decisions.

In other driving scenarios, construction near an intersection, ambient lighting conditions (shade), weather, business operations near the intersection, point-of-interest (POI) opening and closing times may all influence a decision to make a turn, or possibly re-route to another intersection.

Current reliance on motion detectors and assisted braking features in vehicles are unable to account for possible situations at a given intersection.

### BRIEF SUMMARY

The present disclosure provides a system, a method and a computer program product to determine a driving decision at an intersection for a vehicle based on historical and real-time road features of the area of the intersection, using a trained machine learning model, in accordance with various aspects.

Aspects of the disclosure provide a system to determine a driving decision at an intersection based on traffic features associated with the intersection. The system may include at least one memory configured to store computer executable instructions and at least one processor configured to execute the computer executable instructions to obtain a plurality of traffic features related to the intersection of the road based on historical road features and real-time road features associated with the road; determine, a turning confidence index for the intersection of a road, based on the plurality of traffic features related to the intersection of the road; and determine the driving decision associated with attempting to turn at the intersection of the road.

Aspects of the disclosure provide a method to determine a driving decision at an intersection based on traffic features associated with the intersection. The method may comprise obtaining a plurality of traffic features related to the intersection of the road based on historical road features and real-time road features associated with the road; determining a turning confidence index for the intersection of a road, based on the plurality of traffic features related to the intersection of the road; and determining the driving decision associated with attempting to turn at the intersection of the road.

Aspects of the disclosure provide a computer program product comprising at least one non-transitory computer-readable storage medium having stored thereon computer-executable instructions which when executed by a computer, cause the computer to carry out operations to determine a driving decision at an intersection based on traffic features associated with the intersection. The operations may comprise obtaining a plurality of traffic features related to the intersection of the road based on historical road features and real-time road features associated with the road; determining a turning confidence index for the intersection of a road, based on the plurality of traffic features related to the intersection of the road; and determining the driving decision associated with attempting to turn at the intersection of the road.

The foregoing summary is illustrative only and is not intended to be in any way limiting. In addition to the illustrative aspects, aspects, and features described above, further aspects, aspects, and features will become apparent by reference to the drawings and the following detailed description.

### BRIEF DESCRIPTION OF THE DRAWINGS

Having thus described certain aspects of the disclosure in general terms, reference will now be made to the accompanying drawings, which are not necessarily drawn to scale, and wherein:

FIG. 1 illustrates a schematic diagram of a network environment 100 of a system 102 for determining a driving decision in accordance with an example aspect;

FIG. 2 illustrates a block diagram of the system for determining a driving decision for a vehicle at an intersection, in accordance with an example aspect;

FIG. 3 illustrates an example the map or geographic database for use by the system for determining a driving decision for a vehicle at an intersection, in accordance with an example aspect; and

FIG. 4 illustrates a flowchart 400 for acts taken in an exemplary method for determining a driving decision at an intersection based on traffic features in the geographic region around the intersection, in accordance with an aspect.

### DETAILED DESCRIPTION

Some aspects of the present disclosure will now be described more fully hereinafter with reference to the accompanying drawings, in which some, but not all, aspects are shown. Indeed, various aspects may be embodied in many different forms and should not be construed as limited to the aspects set forth herein; rather, these aspects are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with aspects of the present disclosure. Thus, use of any such terms should not be taken to limit the spirit and scope of aspects of the present disclosure.

For purposes of this disclosure, though not limiting or exhaustive, “vehicle” refers to standard gasoline powered vehicles, hybrid vehicles, an electric vehicle, a fuel cell vehicle, and/or any other mobility implement type of vehicle (e.g., bikes, scooters, etc.). The vehicle includes parts related to mobility, such as a powertrain with an engine, a transmission, a suspension, a driveshaft, and/or wheels, etc. The vehicle may be a non-autonomous vehicle or an autonomous vehicle. The term autonomous vehicle (AV) may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to lane marking indicators (lane marking type, lane marking intensity, lane marking color, lane marking offset, lane marking width, or other characteristics) and driving commands or navigation commands. In one aspect, the vehicle may be assigned with an autonomous level. An autonomous level of a vehicle can be a Level 0 autonomous level that corresponds to a negligible automation for the vehicle, a Level 1 autonomous level that corresponds to a certain degree of driver assistance for the vehicle, a Level 2 autonomous level that corresponds to partial automation for the vehicle, a Level 3 autonomous level that corresponds to conditional automation for the vehicle, a Level 4 autonomous level that corresponds to high automation for the vehicle, a Level 5 autonomous level that corresponds to full automation for the vehicle, and/or another sub-level associated with a degree of autonomous driving for the vehicle.

A problem arises in vehicle navigation on streets in how to increase safety at intersections where it is very difficult for vehicles to know whether it is safe to engage due to possible light vehicles (bikes, e-bikes, kickscooters, etc) that could suddenly appear and force the vehicle to stop in the middle of the intersection.

In some scenarios, it is frequent that cars turning left (like the white one) have to stop although they started to turn as bikes are coming in the opposite direction and are seen late. The difficulty in seeing light vehicles among parked cars, in the construction work as well as in the shade often present in this area. In addition, the angle to turn left is over 90 degrees. All this make it a very difficult and dangerous intersection.

A first step to address this issue is to detect and map the intersections that present such characteristics. Typically, an intersection may be evaluated for higher risk of danger by considering the number of lanes on the road, opposing traffic, parked cars preventing good visibility of a bike lane, shadow/lighting issues and other obstructions.

The disclosed system for determining a driving decision leverages historical data as well as real-time data to create an intersection “turning confidence” index based on historical data and an ML model. The ML model may leverage historical information and real-time data to compute such an intersection “turning confidence” index.

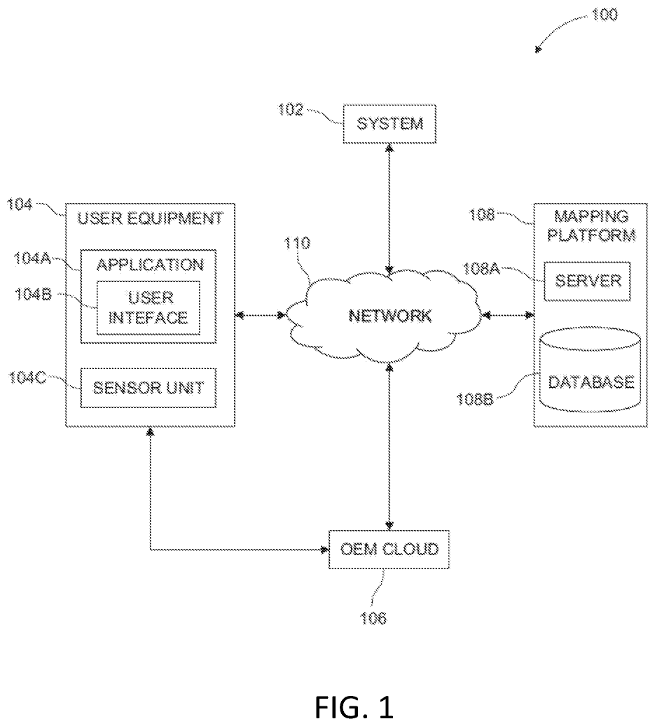

FIG. 1 illustrates a schematic diagram of a network environment 100 of a system 102 for determining a driving decision in accordance with an example aspect. The system 102 may be communicatively coupled with, a user equipment (UE) 104, an OEM cloud 106, a mapping platform 108, via a network 110. The UE 104 may be a vehicle electronics system, onboard automotive electronics/computers, a mobile device such as a smartphone, tablet, smart watch, smart glasses, laptop, wearable device or other UE platforms known to one of skill in the art. The mapping platform 108 may further include a server 108A and a database 108B. The user equipment includes an application 104A, a user interface 104B, and a sensor unit 104C. Further, the server 108A and the database 108B may be communicatively coupled to each other.

The system 102 may comprise suitable logic, circuitry, interfaces and code that may be configured to process the sensor data obtained from the UE 104 for traffic features in a region of the intersection, that may be used to determine a driving decision based in part on sensor data. Traffic features may include historical or static road features such as a time of day and a percentage or a number of successful turns and/or unsuccessful turns; a frequency of emergency stops at the intersection; a number of collisions due to a left turn at the intersection; a time of day when the vehicle is more likely to stop at the intersection; whether a shared vehicle is used in a certain time period and location; historical weather conditions, etc. Traffic features can also include real-time or dynamic road features such as overall business activities at the intersection; a number of bicycle or small vehicle traffic in an area around the intersection; recent use of a shared vehicle in the area around the intersection; real-time weather conditions at the intersection; visibility at the intersection; line-of-sight at the intersection; point-of-interest opening time around the intersection, etc.

The system 102 may be communicatively coupled to the UE 104, the OEM cloud 106, and the mapping platform 108 directly via the network 110. Additionally, or alternately, in some example aspects, the system 102 may be communicatively coupled to the UE 104 via the OEM cloud 106 which in turn may be accessible to the system 102 via the network 110.

All the components in the network environment 100 may be coupled directly or indirectly to the network 110. The components described in the network environment 100 may be further broken down into more than one component and/or combined together in any suitable arrangement. Further, one or more components may be rearranged, changed, added, and/or removed. Furthermore, fewer or additional components may be in communication with the system 102, within the scope of this disclosure.

The system 102 may be embodied in one or more of several ways as per the required implementation. For example, the system 102 may be embodied as a cloud-based service or a cloud-based platform. As such, the system 102 may be configured to operate outside the UE 104. However, in some example aspects, the system 102 may be embodied within the UE 104. In each of such aspects, the system 102 may be communicatively coupled to the components shown in FIG. 1 to carry out the desired operations and wherever required modifications may be possible within the scope of the present disclosure.

The UE 104 may be a vehicle electronics system, onboard automotive electronics/computers, a mobile device such as a smartphone, tablet, smart watch, smart glasses, laptop, wearable device and the like that is portable in itself or as a part of another portable/mobile object, such as, a vehicle known to one of skill in the art. The UE 104 may comprise a processor, a memory and a network interface. The processor, the memory and the network interface may be communicatively coupled to each other. In some example aspects, the UE 104 may be associated, coupled, or otherwise integrated with a vehicle of the user, such as an advanced driver assistance system (ADAS), a personal navigation device (PND), a portable navigation device, an infotainment system and/or other device that may be configured to provide route guidance and navigation related functions to the user. In such example aspects, the UE 104 may comprise processing means such as a central processing unit (CPU), storage means such as on-board read only memory (ROM) and random access memory (RAM), acoustic sensors such as a microphone array, position sensors such as a GPS sensor, gyroscope, a LIDAR sensor, a proximity sensor, motion sensors such as accelerometer, a display enabled user interface such as a touch screen display, and other components as may be required for specific functionalities of the UE 104. Additional, different, or fewer components may be provided. For example, the UE 104 may be configured to execute and run mobile applications such as a messaging application, a browser application, a navigation application, and the like. In accordance with an aspect, the UE 104 may be directly coupled to the system 102 via the network 110. For example, the UE 104 may be a dedicated vehicle (or a part thereof) for gathering data for development of the map data in the database 108B. In some example aspects, the UE 104 may be coupled to the system 102 via the OEM cloud 106 and the network 110. For example, the UE 104 may be a consumer mobile phone (or a part thereof) and may be a beneficiary of the services provided by the system 102. In some example aspects, the UE 104 may serve the dual purpose of a data gatherer and a beneficiary device. The UE 104 may be configured to provide sensor data to the system 102. In accordance with an aspect, the UE 104 may process the sensor data for traffic features that may be used to determine a driving decision at the intersection. Further, in accordance with an aspect, the UE 104 may be configured to perform processing related to determine a “turning confidence” index to assist the driver in making a driving decision.

It is to be understood that the term “driver” and “vehicle” may be used interchangeably, for example, in the context of an autonomous vehicle (“AV”), where a human driver may be riding in a conventional vehicle or in an AV, while an AV may have no human driver per se but can conduct autonomous operations or may defer to a human driver or human operator within or outside of the AV.

The UE 104 may include the application 104A with the user interface 104B to access one or more applications. The application 104B may correspond to, but not limited to, map related service application, navigation related service application and location-based service application. In other words, the UE 104 may include the application 104A with the user interface 104B.

The sensor unit 104C may be embodied within the UE 104. The sensor unit 104C comprising one or more sensors may capture sensor data, in a certain geographic location. In accordance with an aspect, the sensor unit 104C may be built-in, or embedded into, or within interior of the UE 104. The one or more sensors (or sensors) of the sensor unit 104C may be configured to provide the sensor data comprising location data associated with a location of a user. In accordance with an aspect, the sensor unit 104C may be configured to transmit the sensor data to an Original Equipment Manufacturer (OEM) cloud. Examples of the sensors in the sensor unit 104C may include, but not limited to, a microphone, a camera, an acceleration sensor, a gyroscopic sensor, a LIDAR sensor, a proximity sensor, and a motion sensor.

The sensor data may refer to sensor data collected from a sensor unit 104C in the UE 104. In accordance with an aspect, the sensor data may be collected from a large number of mobile phones. In accordance with an aspect, the sensor data may refer to the point cloud data. The point cloud data may be a collection of data points defined by a given coordinates system. In a 3D coordinates system, for instance, the point cloud data may define the shape of some real or created physical objects. The point cloud data may be used to create 3D meshes and other models used in 3D modelling for various fields. In a 3D Cartesian coordinates system, a point is identified by three coordinates that, taken together, correlate to a precise point in space relative to a point of origin. The LIDAR point cloud data may include point measurements from real-world objects or photos for a point cloud data that may then be translated to a 3D mesh or NURBS or CAD model. In accordance with an aspect, the sensor data may be converted to units and ranges compatible with the system 102, to accurately receive the sensor data at the system 102. Additionally, or alternately, the sensor data of a UE 104 may correspond to movement data associated with a user of the user equipment. Without limitations, this may include motion data, position data, orientation data with respect to a reference and the like.

The mapping platform 108 may comprise suitable logic, circuitry, interfaces and code that may be configured to store map data associated with a geographic area around and including an intersection where a turn may take place. The map data may include traffic features and include historical (or static) traffic features such as road layouts, pre-existing road networks, business, educational and recreational locations, POI locations, construction plans, lighting conditions, a time of day and a percentage or a number of successful turns and/or unsuccessful turns; a frequency of emergency stops at the intersection; a number of collisions due to a left turn at the intersection; a time of day when the vehicle is more likely to stop at the intersection; whether a shared vehicle is used in a certain time period and location; historical weather conditions at the intersection or a combination thereof. The server 108A of the mapping platform 108 may comprise processing means and communication means. For example, the processing means may comprise one or more processors configured to process requests received from the system 102 and/or the UE 104. The processing means may fetch map data from the database 108B and transmit the same to the system 102 and/or the UE 104 in a suitable format. In one or more example aspects, the mapping platform 108 may periodically communicate with the UE 104 via the processing means to update a local cache of the map data stored on the UE 104. Accordingly, in some example aspects, map data may also be stored on the UE 104 and may be updated based on periodic communication with the mapping platform 108.

In an aspect, the map data may include, and the database 108B of the mapping platform 108 may store real-time, dynamic data about road features to assist with a driving decision at an intersection. For example, real-time data may be collected for overall business activities at the intersection; a number of bicycle or small vehicle traffic in an area around the intersection; recent use of a shared vehicle in the area around the intersection; real-time weather conditions at the intersection; current visibility at the intersection; line-of-sight at the intersection; point-of-interest opening time around the intersection, etc. Other data records may include computer code instructions and/or algorithms for executing a trained machine learning model that is capable of providing assistance with determining a driving decision.

The database 108B of the mapping platform 108 may store map data of one or more geographic regions that may correspond to a city, a province, a country or of the entire world. The database 108B may store point cloud data collected from the UE 104. The database 108B may store data such as, but not limited to, node data, road segment data, link data, point of interest (POI) data, link identification information, and heading value records. The database 108B may also store cartographic data, routing data, and/or maneuvering data. According to some example aspects, the road segment data records may be links or segments representing roads, streets, or paths, as may be used in calculating a route or recorded route information for determination of one or more personalized routes. The node data may be end points corresponding to the respective links or segments of road segment data. The road link data and the node data may represent a road network, such as used by vehicles, cars, trucks, buses, motorcycles, and/or other entities for identifying location of building.

Optionally, the database 108B may contain path segment and node data records, such as shape points or other data that may represent pedestrian paths, links or areas in addition to or instead of the vehicle road record data. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The database 108B may also store data about the POIs and their respective locations in the POI records. The database 108B may additionally store data about places, such as cities, towns, or other communities, and other geographic features such as bodies of water, and mountain ranges. Such place or feature data can be part of the POI data or can be associated with POIs or POI data records (such as a data point used for displaying or representing a position of a city). In addition, the database 108B may include event data (e.g., traffic incidents, construction activities, scheduled events, unscheduled events, accidents, diversions etc.) associated with the POI data records or other records of the database 108B. Optionally or additionally, the database 108B may store 3D building maps data (3D map model of objects) of structures, topography and other visible features surrounding roads and streets.

The database 108B may be a master map database stored in a format that facilitates updating, maintenance, and development. For example, the master map database or data in the master map database may be in an Oracle spatial format or other spatial format, such as for development or production purposes. The Oracle spatial format or development/production database may be compiled into a delivery format, such as a geographic data files (GDF) format. The data in the production and/or delivery formats may be compiled or further compiled to form geographic database products or databases, which may be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by the UE 104. The navigation-related functions may correspond to vehicle navigation, pedestrian navigation, or other types of navigation. The compilation to produce the end user databases may be performed by a party or entity separate from the map developer. For example, a customer of the map developer, such as a navigation device developer or other end user device developer, may perform compilation on a received map database in a delivery format to produce one or more compiled navigation databases.

As mentioned above, the database 108B may be a master geographic database, but in alternate aspects, the database 108B may be embodied as a client-side map database and may represent a compiled navigation database that may be used in or with end user devices (such as the UE 104) to provide navigation and/or map-related functions. In such a case, the database 108B may be downloaded or stored on the end user devices (such as the UE 104).

The network 110 may comprise suitable logic, circuitry, and interfaces that may be configured to provide a plurality of network ports and a plurality of communication channels for transmission and reception of data, such as the sensor data, map data from the database 108B, etc. Each network port may correspond to a virtual address (or a physical machine address) for transmission and reception of the communication data. For example, the virtual address may be an Internet Protocol Version 4 (IPv4) (or an IPv6 address) and the physical address may be a Media Access Control (MAC) address. The network 110 may be associated with an application layer for implementation of communication protocols based on one or more communication requests from at least one of the one or more communication devices. The communication data may be transmitted or received, via the communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

Examples of the network 110 may include, but is not limited to a wireless channel, a wired channel, a combination of wireless and wired channel thereof. The wireless or wired channel may be associated with a network standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a Long Term Evolution (LTE) networks (for e.g. LTE-Advanced Pro), 5G New Radio networks, ITU-IMT 2020 networks, a plain old telephone service (POTS), and a Metropolitan Area Network (MAN). Additionally, the wired channel may be selected on the basis of bandwidth criteria. For example, an optical fiber channel may be used for a high bandwidth communication. Further, a coaxial cable-based or Ethernet-based communication channel may be used for moderate bandwidth communication.

The system, apparatus, method and computer program product described above may be any of a wide variety of computing devices and may be embodied by either the same or different computing devices. The system, apparatus, etc. may be embodied by a server, a computer workstation, a distributed network of computing devices, a personal computer or any other type of computing device. The system, apparatus, method and computer program product may be configured to determine a driving decision may similarly be embodied by the same or different server, computer workstation, distributed network of computing devices, personal computer, or other type of computing device.

Alternatively, the system, apparatus, method and computer program product may be embodied by a computing device on board a vehicle, such as a computer system of a vehicle, e.g., a computing device of a vehicle that supports safety-critical systems such as the powertrain (engine, transmission, electric drive motors, etc.), steering (e.g., steering assist or steer-by-wire), and/or braking (e.g., brake assist or brake-by-wire), a navigation system of a vehicle, a control system of a vehicle, an electronic control unit of a vehicle, an autonomous vehicle control system (e.g., an autonomous-driving control system) of a vehicle, a mapping system of a vehicle, an Advanced Driver Assistance System (ADAS) of a vehicle), or any other type of computing device carried by the vehicle. Still further, the apparatus may be embodied by a computing device of a driver or passenger on board the vehicle, such as a mobile terminal, e.g., a personal digital assistant (PDA), mobile telephone, smart phone, personal navigation device, smart watch, tablet computer, or any combination of the aforementioned and other types of portable computer devices.

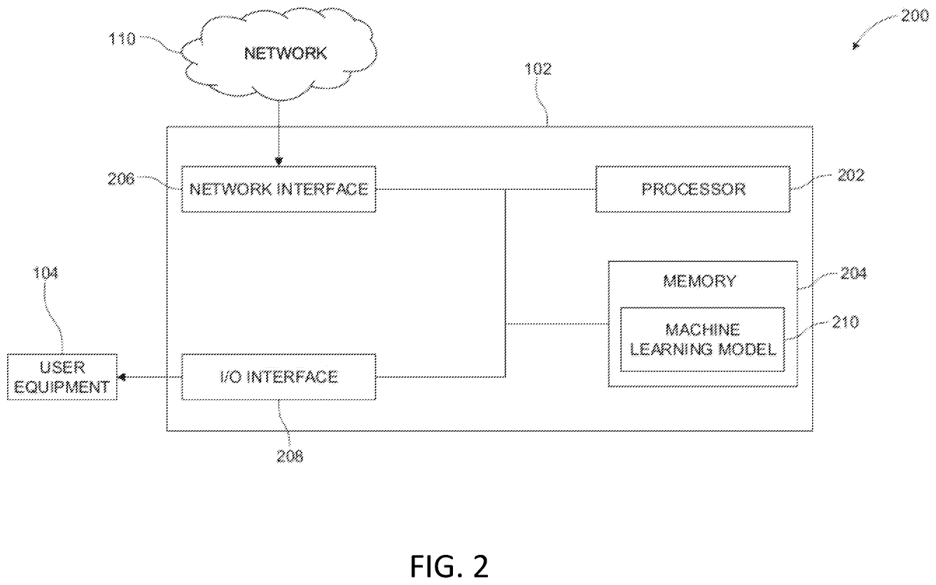

FIG. 2 illustrates a block diagram 200 of the system 102, exemplarily illustrated in FIG. 1, for determining a driving decision for a vehicle at an intersection, in accordance with an example aspect. FIG. 2 is described in conjunction with elements from FIG. 1.

As shown in FIG. 2, the system 102 may comprise a processing means such as a processor 202, storage means such as a memory 204, a communication means, such as a network interface 206, an input/output (I/O) interface 208, and a machine learning model 210. The processor 202 may retrieve computer executable instructions that may be stored in the memory 204 for execution of the computer executable instructions. The system 102 may connect to the UE 104 via the I/O interface 208. The processor 202 may be communicatively coupled to the memory 204, the network interface 206, the I/O interface 208, and the machine learning model 210.

The processor 202 may comprise suitable logic, circuitry, and interfaces that may be configured to execute instructions stored in the memory 204. The processor 202 may obtain sensor data associated with the one or more buildings for time duration. The sensor data may be captured by one or more UE, such as the UE 104. The processor 202 may be configured to determine mobility features associated with the one or more buildings, based on the sensor data. The processor 202 may be further configured to determine, using a trained machine learning model, a driving decision based on a “turning confidence” index, from traffic features associated with the geographic area surrounding and including the intersection.

Examples of the processor 202 may be an Application-Specific Integrated Circuit (ASIC) processor, a Complex Instruction Set Computing (CISC) processor, a central processing unit (CPU), an Explicitly Parallel Instruction Computing (EPIC) processor, a Very Long Instruction Word (VLIW) processor, and/or other processors or circuits. The processor 202 may implement a number of processor technologies known in the art such as a machine learning model, a deep learning model, such as a recurrent neural network (RNN), a convolutional neural network (CNN), and a feed-forward neural network, or a Bayesian model. As such, in some aspects, the processor 202 may include one or more processing cores configured to perform independently. A multi-core processor may enable multiprocessing within a single physical package.

Additionally, or alternatively, the processor 202 may include one or more processors configured in tandem via the bus to enable independent execution of instructions, pipelining and/or multithreading. Additionally, or alternatively, the processor 202 may include one or processors capable of processing large volumes of workloads and operations to provide support for big data analysis. However, in some cases, the processor 202 may be a processor specific device (for example, a mobile terminal or a fixed computing device) configured to employ an aspect of the disclosure by further configuration of the processor 202 by instructions for performing the algorithms and/or operations described herein.

In some aspects, the processor 202 may be configured to provide Internet-of-Things (IoT) related capabilities to users of the UE 104 disclosed herein. The IoT related capabilities may in turn be used to provide smart city solutions by providing real time parking updates, big data analysis, and sensor-based data collection for providing navigation and parking recommendation services. The environment may be accessed using the I/O interface 208 of the system 102 disclosed herein.

The memory 204 may comprise suitable logic, circuitry, and interfaces that may be configured to store a machine code and/or instructions executable by the processor 202. The memory 204 may be configured to store information including processor instructions for training the machine learning model. The memory 204 may be used by the processor 202 to store temporary values during execution of processor instructions. The memory 204 may be configured to store different types of data, such as, but not limited to, sensor data from the UE 104. Examples of implementation of the memory 204 may include, but are not limited to, Random Access Memory (RAM), Read Only Memory (ROM), Electrically Erasable Programmable Read-Only Memory (EEPROM), Hard Disk Drive (HDD), a Solid-State Drive (SSD), a CPU cache, and/or a Secure Digital (SD) card.

The network interface 206 may comprise suitable logic, circuitry, and interfaces that may be configured to communicate with the components of the system 102 and other systems and devices in the network environment 100, via the network 110. The network interface 206 may communicate with the UE 104, via the network 110 under the control of the processor 202. In one aspect, the network interface 206 may be configured to communicate with the sensor unit 104C disclosed in the detailed description of FIG. 1. In an alternative aspect, the network interface 206 may be configured to receive the sensor data from the OEM cloud 106 over the network 110 as described in FIG. 1. In some example aspects, the network interface 206 may be configured to receive location information of a user associated with a UE (such as, the UE 104), via the network 110. In accordance with an aspect, a controller of the UE 104 may receive the sensor data from a positioning system (for example: a GPS based positioning system) of the UE 104. The network interface 206 may be implemented by use of known technologies to support wired or wireless communication of the system 102 with the network 110. Components of the network interface 206 may include, but are not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer circuit.

The I/O interface 208 may comprise suitable logic, circuitry, and interfaces that may be configured to operate as an I/O channel/interface between the UE 104 and different operational components of the system 102 or other devices in the network environment 100. The I/O interface 208 may facilitate an I/O device (for example, an I/O console) to receive an input (e.g., sensor data from the UE 104 for a time duration) and present an output to one or more UE (such as, the UE 104) based on the received input. In accordance with an aspect, the I/O interface 208 may obtain the sensor data from the OEM cloud 106 to store in the memory 202. The I/O interface 208 may include various input and output ports to connect various I/O devices that may communicate with different operational components of the system 102. In accordance with an aspect, the I/O interface 208 may be configured to output the driving decision and/or alerts related to the driving decision to a user device, such as, the UE 104 of FIG. 1.

In example aspects, the I/O interface 208 may be configured to provide the data associated with determined driving decisions to the database 108A to update the map of a certain geographic region. In accordance with an aspect, a user requesting information in a geographic region may be updated about historical (or static) road features, such as a time of day and a percentage or a number of successful turns and/or unsuccessful turns; a frequency of emergency stops at the intersection; a number of collisions due to a left turn at the intersection; a time of day when the vehicle is more likely to stop at the intersection; whether a shared vehicle is used in a certain time period and location; historical weather conditions at the intersection; and real-time (or dynamic) road features, such as overall business activities at the intersection; a number of bicycle or small vehicle traffic in an area around the intersection; recent use of a shared vehicle in the area around the intersection; real-time weather conditions at the intersection; visibility at the intersection; line-of-sight at the intersection; point-of-interest opening time around the intersection, etc. potentially problematic turns in a geographic area, etc. Examples of the input devices may include, but is not limited to, a touch screen, a keyboard, a mouse, a joystick, a microphone, and an image-capture device. Examples of the output devices may include, but is not limited to, a display, a speaker, a haptic output device, or other sensory output devices.

In accordance with an aspect, the processor 202 may train the machine learning model 210 to determine a driving decision for a vehicle at an intersection based on traffic features in a geographic region. In an aspect of the disclosure, the processor 202 may determine a driving decision for a vehicle at an intersection based on a plurality of traffic features related to the intersection of the road, such as historical road features and/or real-time road features associated with the road. In an aspect, a weighted linear regression model may be used to determine the driving decision for the vehicle at the intersection. In another aspect, a look-up table for determining the driving decision for the vehicle at the intersection, where the look-up table is populated with entries of prior left turn decisions based on input factors.

In another aspect, a machine learning model, such as trained machine learning model 210 discussed earlier, may be used to determine the driving decision for the vehicle at the intersection. In accordance with an aspect, the trained machine learning model 210 may be trained offline to obtain a classifier model to determine the driving decision for the vehicle at the intersection based on such as historical road features and/or real-time road features associated with the road. For the training of the trained machine learning model 210, different feature selection techniques and classification techniques may be used. The system 102 may be configured to obtain the trained machine learning model 210 and the trained machine learning model 210 model may leverage historical information and real-time data to compute such an intersection “turning” confidence index based on historical information including the time of day and the percentage/number of successful turns/unsuccessful turns, weather conditions, how many vehicles have had to stop in emergency in that time window at that intersection, how many collisions happened due to a left turn at that intersection, at what time of the day is a vehicle more likely to have to stop, if shared vehicles are mostly used in that time and space partition, etc. In addition to this historical data, the system 102 may put more weight on real-time information for the trained machine learning model 210, captured by sensors but also data available from other parameters that influence the dangerousness of that intersection, including, for example overall business in that intersection, a number of bikes/bike traffic in that region, overall use of shared vehicles in the area, real-time weather data, POI opening time around this intersection, etc. In one aspect, supervised machine learning techniques may be utilized where ground truth data is used to train the model for different scenarios and then in areas where there is not sufficient ground truth data, the trained machine learning model 210 can be used to predict features or results.

In an aspect, the trained machine learning model 210 may be complemented or substituted with a transfer learning model. The transfer learning model may be used when the plurality of historical road features and/or real-time road features is unavailable, sparse, incomplete, corrupted or otherwise unreliable for determining the driving decision at the intersection safely. The transfer learning model may then use historical road features and/or real-time road features from other prior locations and left turns to assist in determining the “turning” confidence index and driving decision at the intersection. For example, if historical road features and/or real-time road features from prior intersections and left turn attempts indicate that a larger presence of shared vehicles or limited line-of-sight present resulted in a higher “turning” confidence index, that set of information may be probative for determining the “turning” confidence index in the current situation the driver faces.

In an aspect, the “turning” confidence index and/or the driving decision may be determined by weighting historical road features such as a time of day and a percentage or a number of successful turns and/or unsuccessful turns; a frequency of emergency stops at the intersection; a number of collisions due to a left turn at the intersection; a time of day when the vehicle is more likely to stop at the intersection; whether a shared vehicle is used in a certain time period and location; historical weather conditions at the intersection, etc. and/or real-time road features, such as overall business activities at the intersection; a number of bicycle or small vehicle traffic in an area around the intersection; recent use of a shared vehicle in the area around the intersection; real-time weather conditions at the intersection; visibility at the intersection; line-of-sight at the intersection; point-of-interest opening time around the intersection, etc. For example, at an intersection with a high historical accident rate at that intersection, large amounts of traffic due to a POI releasing drivers at that time window, coupled with real-time sensor data on severe weather conditions reported in the area now, the “turning” confidence index may be higher with the previously described factors weighting the model. The “turning” confidence index and driving decision may be affected adversely—i.e., reporting higher risk at that intersection and advising on alternative turn opportunities at another intersection. In an aspect, if historical road features indicate a well-signed intersection with wide open line-of-sight, low traffic volume at that time of day, and real-time sensor data indicating no accidents nearby or severe weather, the “turning” confidence index may be lower by weighing the previously described road/traffic features as more important to a lower risk determination to make a left turn at this intersection. Other scenarios and weighting factors may be possible to enhance the usefulness of the system 102.

Datasets comprising real-time road features from the obtained sensor data may be used for building the trained machine learning model 210 with “turning” confidence indices and driving decisions at a given intersection to be determined dynamically. For building the machine learning model 210, the sensor data may be obtained for fixed time duration, and a reference “turning” confidence index and/or driving decision may be assigned in the training data (such as, the sensor data) to learn from. Further, the traffic features that represent motion dynamics or stationarity may be determined, stored and fed to the machine learning model 210 building technique. Further, for building the machine learning model 210, the sensor data may be fed to the model building technique to run it to build and obtain the machine learning model 210. The “turning” confidence index and driving decision may be target outputs used to build the machine learning model 210, and the traffic features that represent motion dynamics or stationarity constitute as input to the machine learning model 210 corresponding to the target output. In accordance with an aspect, the machine learning model building technique may correspond to a classification technique, such as, but not limited to, decision trees and random forest.

In accordance with an aspect, various data sources may provide the historical road features and/or real-time road features as an input to the machine learning model 210. Examples of the machine learning model 210 may include, but not limited to, Decision Tree (DT), Random Forest, and Ada Boost. In accordance with an aspect, the memory 204 may include processing instructions for training of the machine learning model 210 with data set that may be real-time (or near real time) data or historical data. In accordance with an aspect, the data may be obtained from one or more service providers.

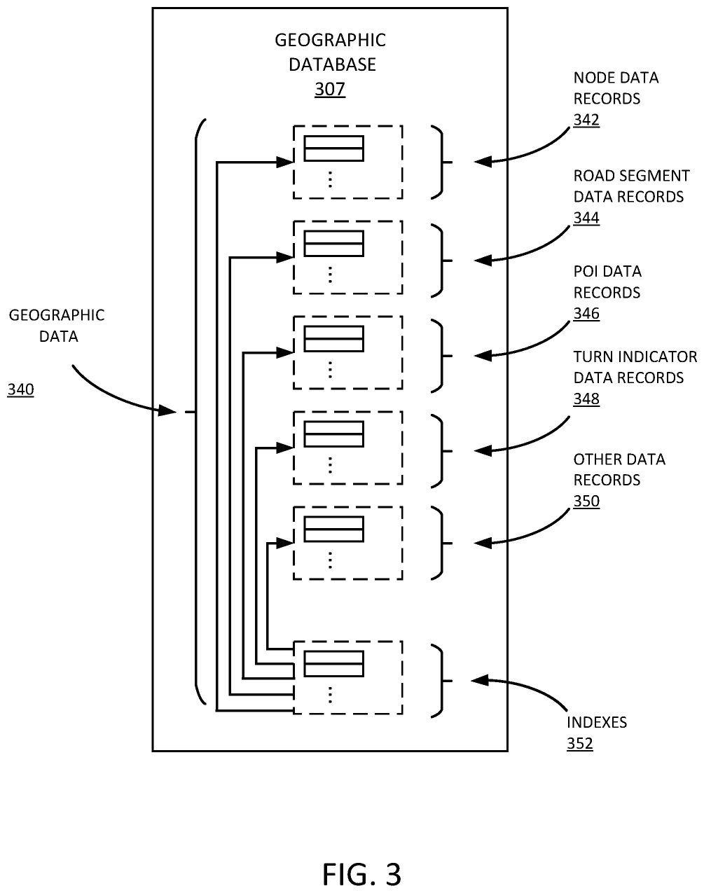

FIG. 3 illustrates an example map or geographic database 307, which may include various types of geographic data 340. The database may be similar to or an example of the database 108B. The data 340 may include but is not limited to node data 342, road segment or link data 344, map object and point of interest (POI) data 346, turn indicator data records 348, or the like (e.g., other data records 350 such as traffic data, sidewalk data, road dimension data, building dimension data, vehicle dimension/turning radius data, etc.). Other data records may include computer code instructions and/or algorithms for executing a trained machine learning model that is capable of providing a “turning confidence” index and driving decision based on traffic features.

A profile of end user driving data (e.g., a driving profile) such as end user driving and turning patterns (e.g., hesitations/cautious, slow, fast, etc.) may be obtained by any functional manner including those detailed in U.S. Pat. Nos. 9,766,625 and 9,514,651, both of which are incorporated herein by reference. This data may be stored in one of more of the databases discussed above including as part of the turn indicator records 348 in some aspects. This data may also be stored elsewhere and supplied to the system 102 via any functional means.

In one aspect, the following terminology applies to the representation of geographic features in the database 307. A “Node”—is a point that terminates a link, a “road/line segment”—is a straight line connecting two points, and a “Link” (or “edge”) is a contiguous, non-branching string of one or more road segments terminating in a node at each end. In one aspect, the geographic database 307 follows certain conventions. For example, links do not cross themselves and do not cross each other except at a node. Also, there are no duplicated shape points, nodes, or links. Two links that connect each other have a common node.

The geographic database 307 may also include cartographic data, routing data, and/or maneuvering data as well as indexes 352. According to some example aspects, the road segment data records may be links or segments representing roads, streets, or paths, as may be used in calculating a route or recorded route information for determination of one or more personalized routes. The node data may be end points (e.g., intersections) corresponding to the respective links or segments of road segment data. The road link data and the node data may represent a road network, such as used by vehicles, cars, trucks, buses, motorcycles, bikes, scooters, and/or other entities.

Optionally, the geographic database 307 may contain path segment and node data records or other data that may represent pedestrian paths or areas in addition to or instead of the vehicle road record data, for example. The road/link segments and nodes can be associated with attributes, such as geographic coordinates, street names, address ranges, speed limits, turn restrictions at intersections, and other navigation related attributes, as well as POIs, such as fueling stations, hotels, restaurants, museums, stadiums, offices, auto repair shops, buildings, stores, parks, etc. The geographic database 307 can include data about the POIs and their respective locations in the POI records. The geographic database 307 may include data about places, such as cities, towns, or other communities, and other geographic features such as bodies of water, mountain ranges, etc. Such place or feature data can be part of the POI data or can be associated with POIs or POI data records (such as a data point used for displaying or representing a position of a city). In addition, the map database can include event data (e.g., traffic incidents, construction activities, scheduled events, unscheduled events, etc.) associated with the POI data records or other records of the map database.

The geographic database 107 may be maintained by a content provider e.g., the map data service provider and may be accessed, for example, by the content or service provider processing server. By way of example, the map data service provider can collect geographic data and dynamic data to generate and enhance the map database and dynamic data such as traffic-related data contained therein. There can be different ways used by the map developer to collect data. These ways can include obtaining data from other sources, such as municipalities or respective geographic authorities, such as via global information system databases. In addition, the map developer can employ field personnel to travel by vehicle along roads throughout the geographic region to observe features and/or record information about them, for example. Also, remote sensing, such as aerial or satellite photography and/or LiDAR, can be used to generate map geometries directly or through machine learning as described herein. However, the most ubiquitous form of data that may be available is vehicle data provided by vehicles, such as mobile device, as they travel the roads throughout a region.

The geographic database 107 may be a master map database, such as an HD map database, stored in a format that facilitates updates, maintenance, and development. For example, the master map database or data in the master map database can be in an Oracle spatial format or other spatial format (e.g., accommodating different map layers), such as for development or production purposes. The Oracle spatial format or development/production database can be compiled into a delivery format, such as a geographic data files (GDF) format. The data in the production and/or delivery formats can be compiled or further compiled to form geographic database products or databases, which can be used in end user navigation devices or systems.

For example, geographic data may be compiled (such as into a platform specification format (PSF) format) to organize and/or configure the data for performing navigation-related functions and/or services, such as route calculation, route guidance, map display, speed calculation, distance and travel time functions, and other functions, by a navigation device, such as by a vehicle represented by mobile device, for example. The navigation-related functions can correspond to vehicle navigation, pedestrian navigation, or other types of navigation. The compilation to produce the end user databases can be performed by a party or entity separate from the map developer. For example, a customer of the map developer, such as a navigation device developer or other end user device developer, can perform compilation on a received map database in a delivery format to produce one or more compiled navigation databases.

As mentioned above, the geographic database 307 may be a master geographic database, but in alternate aspects, a client-side map database may represent a compiled navigation database that may be used in or with end user devices to provide navigation and/or map-related functions. For example, the map database may be used with the mobile device to provide an end user with navigation features. In such a case, the map database can be downloaded or stored on the end user device which can access the map database through a wireless or wired connection, such as via a processing server and/or a network, for example.

The records for turn indicator data records 348 may include various points of data such as, but not limited to: road images, vehicle images, images of objects proximate to a vehicle, location and time/date information, height, weight, and data on other vehicles or objects present at the time when a left turn was detected, etc. End user driving profile data may also be included in the turn indicator data records 348 (or stored elsewhere). Driving profile data such as the driving capabilities, reaction time, typical turn duration, etc. may be included in some driving profiles.

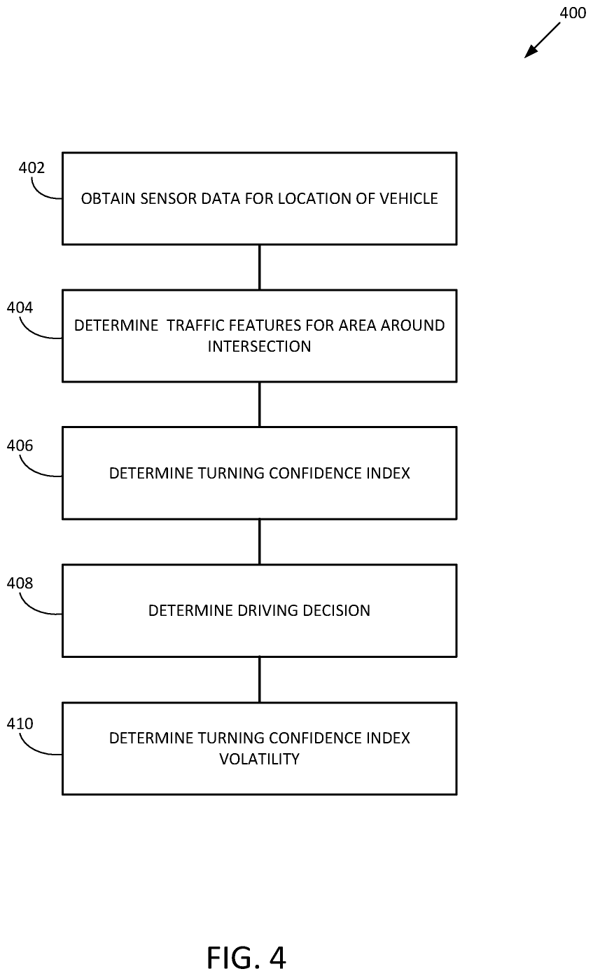

FIG. 4 illustrates a flowchart 400 for acts taken in an exemplary method for determining a driving decision at an intersection based on traffic features in the geographic region around the intersection, in accordance with an aspect. More, less or different steps may be provided. FIG. 4 is explained in conjunction with FIG. 1 to FIG. 3. The control starts at act 402.

At act 402, sensor data associated with the location of the vehicle in relation to a destination and intersections between the vehicle and the destination traffic features may be obtained for a time duration. The processor 202 may be configured to obtain sensor data associated with the traffic features and other nearby vehicle positions, nearby bicycle positions, or nearby pedestrian positions; a weather sensor; a real-time database of point-of-interest data, construction data, business data near the intersection, shared vehicle usage data, lighting, visibility or the like. The sensor data may be obtained from one or more user equipment (UE). In accordance with an aspect, the UE may correspond to a mobile phone or an electronic device associated with the user or vehicle.

At act 404, traffic features associated with the geographic region containing the intersection may be determined based on historical road features and real-time traffic features. The processor 202 may be configured to determine traffic features based on the sensor data. The processor 202 may also be configured to determine traffic features based on data from database, such as database 108B containing historical road features and real-time traffic features. Historical road features may include a time of day and a percentage or a number of successful turns and/or unsuccessful turns; a frequency of emergency stops at the intersection; a number of collisions due to a left turn at the intersection; a time of day when the vehicle is more likely to stop at the intersection; whether a shared vehicle is used in a certain time period and location; historical weather conditions at the intersection or the like. Real-time road features may include overall business activities at the intersection; a number of bicycle or small vehicle traffic in an area around the intersection; recent use of a shared vehicle in the area around the intersection; real-time weather conditions at the intersection; visibility at the intersection; line-of-sight at the intersection; point-of-interest opening time around the intersection or the like.

At act 406, a “turning confidence” index is determined using a using a trained machine learning model based on the plurality of traffic features related to the intersection of the road. The processor 202 may be further configured to calculate “turning confidence” scores for each of the traffic features. The rank for each traffic feature may indicate a measure of relevance/importance of the information, risk factors related to the information, freshness/recentness of the information, or other weighting factors considered valuable to be imparted by the respective traffic feature in determination of the driving decision for the relevant intersection. The confidence scores may correspond to a rank of each of the traffic features. An order of the rank starts with a top ranked traffic feature that corresponds to a most informative in relation to risk of turning given the traffic feature.

In an aspect of the disclosure, the “turning confidence” index may be determined by the trained machine learning model 210 incorporating the effects of shared ride vehicles in the area, such as AV or human-operated shared rides. The trained machine learning model 210 may uncover a correlation found between the usage rate of shared vehicles in an area and the number of “emergency stops in the middle of a given intersection.” In the similar manner, the usage of shared vehicles in an area may be correlated with higher accident rates at that intersection. If there is no real-time road data available for the intersection, the system 102 may consider only historical road data. Real-time road data may be obtained anew for the area, including whether bikes or other micro-transportation are in the vicinity. This real-time road data may be detected using the vehicle camera, PIR sensors, LIDAR or other image sensors.

In an aspect of the disclosure, the trained machine learning model 210 may determine the “turning confidence” index using line-of-sight (LoS) calculations from sensors and/or historical road feature information. Visibility and LoS may influence the determination of a driving decision at the intersection, where low visibility and LoS will tend to lead to a higher “turning confidence” index, indicating higher risk for turning at the intersection.

In an aspect of the disclosure, the trained machine learning model may determine the turning confidence index using a multilinear regression model that assigns weights to one or more of the plurality of traffic features based on a correlation between the historical road features and the more real-time road features and an output of the trained machine learning model 102.

At act 408, using a trained machine learning model 210, the driving decision may be determined. The processor 202 may be configured to determine, using the trained machine learning model, the driving decision, associated with attempting to turn at the intersection of the road based on the “turning confidence” index. The trained machine learning model 210 may correspond to a selective-learning machine learning model.

In an aspect of the disclosure, the determined driving decision may be to recommend that the vehicle re-route and take a different route to the destination, if the “turning confidence” index is above a certain threshold, considered to be higher in risk or danger in attempting to turn at the intersection.

In an aspect of the disclosure, an AV operating in an AV control condition (i.e., the AV is operating without human direction) may transition a vehicle control condition from an AV control condition to a manual driver control condition if the turning confidence index is above a threshold level, considered to be higher in risk or danger in attempting to turn at the intersection.

In an aspect of the disclosure, the driving decision may be complemented by providing an audible alert or a visual alert to the driver when approaching the intersection.

In an aspect of the disclosure, the driving decision may include displaying a map of an area around the intersection, where a coloration of the area around the intersection is determined by the turning confidence index. For example, a higher “turning confidence” index area and/or intersection may be displayed as red, while lower “turning confidence” index areas/intersections may be displayed as green. The adjusted coloration of the map and other indicia may be stored as a separate map layer in the map database 108B.

At act 410, the system may determine a “turning confidence” index volatility measure. For a given intersection, the system 102 may measure the how the “turning confidence” index changes over time as Iturning index (i)—turning index (i+1) IN, where N is the number of time periods and an time period is a periodic time point such as every hour. In an aspect, the “turning confidence” index volatility may demonstrate how significant are the changes in the “turning confidence” index across time. If the “turning confidence” volatility index is high for a given intersection, the system 102 may assign more sensor resources and/or processing power to the computation of risk factors at that intersection.

Blocks of the flowchart 400 support combinations of means for performing the specified functions and combinations of operations for performing the specified functions for performing the specified functions. It will also be understood that one or more blocks of the flowchart 400, and combinations of blocks in the flowchart 400, can be implemented by special purpose hardware-based computer systems which perform the specified functions, or combinations of special purpose hardware and computer instructions.

Alternatively, the system may comprise means for performing each of the operations described above. In this regard, according to an example aspect, examples of means for performing operations may comprise, for example, the processor 202 and/or a device or circuit for executing instructions or executing an algorithm for processing information as described above.

On implementing the method 400 disclosed herein, the end result generated by the system 102 is a tangible determination of a driving decision. The determination of the driving decision is of utmost importance as only highly accurate output data from the determined “turning confidence” index may be further used in the driving decisions such as, but not limited to, construction planning/implementation, urban planning, such as determining where certain intersections are located, the rules for the intersection, placement of signage, traffic lights, signage, lane and crosswalk indicators, bike or light vehicle paths, pedestrian paths and business location offsets from the road, among other decisions.

Although the aforesaid description of FIGS. 1-4 is provided with reference to the sensor data, however, it may be understood that the disclosure would work in a similar manner for different types and sets of data as well. The system 102 may generate/train the machine learning model 210 to evaluate different sets of data at various geographic locations. Additionally, or optionally, the determined “turning confidence” index and/or driving decision in the form of output data may be provided to an end user, as an update which may be downloaded from the mapping platform 110. The update may be provided as a run time update or a pushed update.

It will be understood that each block of the flowcharts and combination of blocks in the flowcharts may be implemented by various means, such as hardware, firmware, processor, circuitry, and/or other communication devices associated with execution of software including one or more computer program instructions. For example, one or more of the procedures described above may be embodied by computer program instructions. In this regard, the computer program instructions which embody the procedures described above may be stored by a memory device 14 of an apparatus 10 employing an aspect of the present disclosure and executed by the processing circuitry 12. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other aspects of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific aspects disclosed and that modifications and other aspects are intended to be included within the scope of the appended claims. Furthermore, in some aspects, additional optional operations may be included. Modifications, additions, or amplifications to the operations above may be performed in any order and in any combination.

Moreover, although the foregoing descriptions and the associated drawings describe example aspects in the context of certain example combinations of elements and/or functions, it should be appreciated that different combinations of elements and/or functions may be provided by alternative aspects without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A system to determine a driving decision for a user driving a vehicle attempting to turn at an intersection of a road, the system comprising:
at least one memory configured to store computer executable instructions; and
at least one processor configured to execute the computer executable instructions to:
obtain a plurality of traffic features related to the intersection of the road based on historical road features and/or real-time road features associated with the road;
determine, a turning confidence index for the intersection of a road, based on the plurality of traffic features related to the intersection of the road; and
determine the driving decision associated with attempting to turn at the intersection of the road.

2. The system of claim 1, where the computer executable instructions to determine the turning confidence index and/or determine the driving decision comprise computer executable instructions to use a trained machine learning model.

3. The system of claim 1, where the historical road features comprise a time of day and a percentage or a number of successful turns and/or unsuccessful turns; a frequency of emergency stops at the intersection; a number of collisions due to a left turn at the intersection; a time of day when the vehicle is more likely to stop at the intersection; whether a shared vehicle is used in a certain time period and location; historical weather conditions at the intersection or a combination thereof.

4. The system of claim 3, where the historical road features are obtained from a database of historical road feature data associated with the area around the intersection.

5. The system of claim 1, where the real-time road features comprise overall business activities at the intersection; a number of bicycle or small vehicle traffic in an area around the intersection; recent use of a shared vehicle in the area around the intersection; real-time weather conditions at the intersection; visibility at the intersection; line-of-sight at the intersection; point-of-interest opening time around the intersection or a combination thereof.

6. The system of claim 5, where the real-time road features are obtained from one or more sensors configured to detect nearby vehicle positions, nearby bicycle positions, or nearby pedestrian positions; a weather sensor; a real-time database of point-of-interest data, construction data, business data near the intersection, shared vehicle usage data or a combination thereof.

7. A method to determine a driving decision for a vehicle attempting to turn at an intersection of a road, the method comprising:
obtaining a plurality of traffic features related to the intersection of the road based on one or more static road features and/or one or more dynamic road features associated with the road;
determining, a turning confidence index for the intersection of a road, based on the plurality of traffic features related to the intersection of the road; and
determining the driving decision associated with attempting to turn at the intersection of the road.

8. The method of claim 7, where determining the turning confidence index and/or determining the driving decision comprises using a trained machine learning model.

9. The method of claim 8, where using the trained machine learning model comprises using a multilinear regression model that assigns weights to one or more of the plurality of traffic features based on a correlation between the one or more static road features and the one or more dynamic road features and an output of the trained machine learning model.

10. The method of claim 7, where determining the driving decision comprises providing an audible alert or a visual alert to the vehicle or a combination thereof when approaching the intersection.

11. The method of claim 7, where determining the driving decision comprises re-routing the vehicle to a route that avoids the intersection.

12. The method of claim 7, where determining the driving decision comprises, if the turning confidence index is above a threshold level, transitioning a vehicle control condition from an autonomous vehicle control condition to a manual driver control condition.

13. The method of claim 7, where determining the driving decision comprises displaying a map of an area around the intersection, where a coloration of the area round the intersection is determined by the turning confidence index.

14. The method of claim 7, further comprising determining a turning confidence index volatility associated with the intersection, where determining the turning confidence index volatility comprises assigning additional computational resources, sensor resources or a combination thereof to supply the trained machine learning model.

15. A computer program product comprising a non-transitory computer readable medium having stored thereon computer executable instructions, which when executed by one or more processors, cause the one or more processors to carry out operations to determine a driving decision for a user driving a vehicle attempting to turn at an intersection of a road, the operations comprising:
obtaining a plurality of traffic features related to the intersection of the road based on one or more static road features and one or more dynamic road features associated with the road;
determining a turning confidence index for the intersection of a road, based on the plurality of traffic features related to the intersection of the road; and
determining the driving decision associated with attempting to turn at the intersection of the road.

16. The computer program product of claim 15, where the operations for determining a turning confidence index and/or determining the driving decision comprise operations using a trained machine learning model.

17. The computer program product of claim 15, where the historical road features comprise a time of day and a percentage or a number of successful turns and/or unsuccessful turns; a frequency of emergency stops at the intersection; a number of collisions due to a left turn at the intersection; a time of day when the vehicle is more likely to stop at the intersection; whether a shared vehicle is used in a certain time period and location; historical weather conditions at the intersection or a combination thereof.

18. The computer program product of claim 15, where the real-time road features comprise overall business activities at the intersection; a number of bicycle or small vehicle traffic in an area around the intersection; recent use of a shared vehicle in the area around the intersection; real-time weather conditions at the intersection; visibility at the intersection; line-of-sight at the intersection; point-of-interest opening time around the intersection or a combination thereof.

19. The computer program product of claim 15, where the real-time road features are obtained from at least one of the following: one or more sensors configured to detect nearby vehicle positions, nearby bicycle positions, or nearby pedestrian positions; a weather sensor; a real-time database of point-of-interest data, construction data, business data near the intersection or shared vehicle usage data.

20. The computer program product of claim 16, further comprising operations for determining a turning confidence index volatility associated with the intersection, where determining the turning confidence index volatility comprises assigning additional computational resources, sensor resources or a combination thereof to supply the trained machine learning model.
